(19) United States
(12) Patent Application Publication
(10) Pub. No.: US 2004/0182972 A1
(43) Pub. Date: Sep. 23, 2004

(54) Electrical connector holder

(76) Inventors: Gregory J. Bakos, Mason, OH (US); Gary L. Long, Buckinghamshire (GB)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/392,159

(22) Filed: Mar. 19, 2003

(51) Int. Cl. F16L 3/22

(52) U.S. Cl. 248/68.1

(57) ABSTRACT

A holder for releasably engaging at least two electrical end connectors is provided. The holder provides center to center spacing of the end connectors. The holder can be injection molded from a plastic material. In one embodiment, the holder includes a body portion and a plurality of tab extensions for releasably holding electrical end connectors.

### FIELD OF THE INVENTION

The present invention relates, in general, to electrical connectors and more particularly to devices for holding electrical connectors for use with surgical devices.

### BACKGROUND OF THE INVENTION

Medical devices, such as electrosurgical devices, may be coupled to electrical or electronic devices, such as for instance an electronic control, or a generator such as a current supply or other power supply. For instance, in electro-cautery or electro-ablation devices, a tissue cauterizing or tissue ablating device typically includes one or more electrodes which are connected through electrical leads (wires) to an appropriate generator. The wires terminate in end connectors, such as “banana plug” type connectors, which fit into corresponding receptacles in the generator. Different generators have different types of receptacles in which to plug in devices. Wires with end connectors that are not connected together can become tangled, which is generally not desirable. Permanently joining electrical connectors, such as in a molded plastic casing, can reduce tangling. However, such permanent connection may preclude use of different generators if the different generators have different receptacle spacing.

### SUMMARY OF THE INVENTION

The present invention is directed to an apparatus that, in one embodiment, can be used to reduce tangling of separate electrical leads, while accommodating electrical devices having different electrical connector receptacle spacing.

In one embodiment, the present invention provides a holder for providing a desired center to center spacing of electrical end connectors, such as banana plug type end connectors. The holder can include a first portion for releasably holding an end connector and a second portion of releasably holding an end connector. In one embodiment, the holder comprises a body portion, a first plurality of tab extensions for releasably holding an first end connector, and a second plurality of tab extensions for releasably holding a second end connector.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is a schematic illustration of the electrical connector holder of the present invention being used to hold electrical end connectors at the end of wire leads in spaced apart relationship for insertion into an electrical device, such as an electric current generator.

FIG. 2 is an isometric view of an embodiment of the electrical connector holder of the present invention with no electrical end connectors engaged by the holder.

FIG. 3 is an isometric view of an embodiment of the electrical connector holder showing two banana plug type electrical end connectors releasably held by the electrical connector holder.

FIG. 4. is a cross-sectional view of an electrical connector holder of the present invention showing the center to center spacing of electrical end connectors provided by the holder.

FIG. 5 is a cross-sectional view of the electrical connector holder of FIG. 4 showing the holder deformed or otherwise modified to provide a different center to center spacing of the electrical end connectors.

FIG. 6 is an isometric view of an embodiment of the electrical connector holder wherein one portion of the holder is movable relative to another portion of the holder to provide different center to center spacings of the electrical end connectors.

### DETAILED DESCRIPTION OF THE INVENTION

The present invention provides a device for releasably holding two or more electrical end connectors. By “releasably holding” it is meant that the electrical end connectors can be engaged by the holder and subsequently removed from the holder without disassembling the holder, removing a portion of the holder, destroying the holder, or otherwise rendering the holder unsuitable for subsequent use.

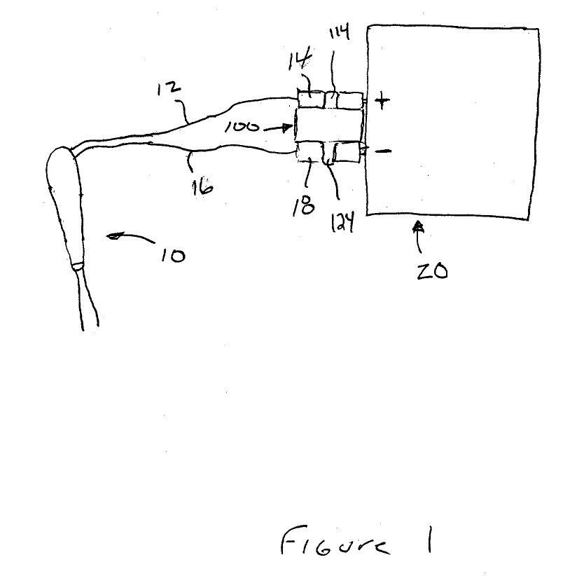

Referring to FIG. 1, a surgical device 10 (e.g. such as an electro-cautery or electro-ablation device having monopolar or bipolar electrode configurations) is shown connected to a generator device 20 (e.g. an electrosurgical generator for providing radio frequency energy to the device 10) by wires 12 and 16. A commercially available generator is a Pegasys generator available from Ethicon Endo-Surgery of Cincinnati, Ohio.

Wire 12 is shown terminating in an electrical end connector 14, and wire 16 is shown terminating in an electrical end connector 18. End connectors 14 and 18 have plug portions that fit into sockets in the generator device 20. Electrical end connectors 14 and 18 can be “banana plug” type connectors as are well known in the art, and as shown in FIG. 3. An electrical connector holder 100 of the present invention is shown releasably holding the connectors 14 and 18 in FIG. 1 and FIG. 3.

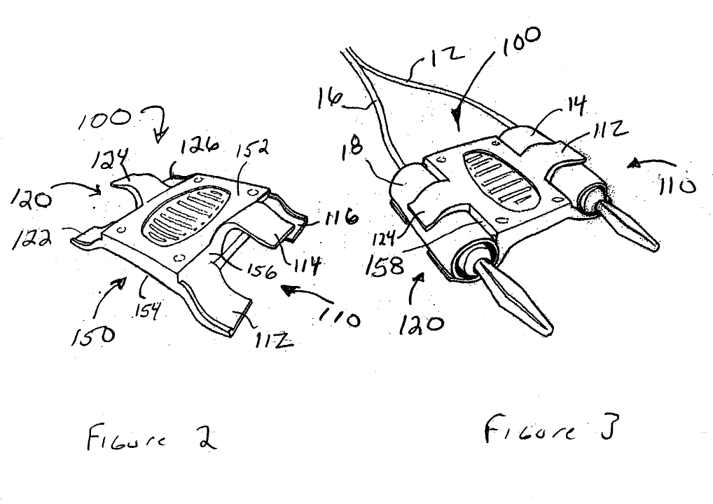

FIG. 2 illustrates an embodiment of the electrical connector holder 100 of the present invention with no electrical end connectors engaged by the holder, and FIG. 3 illustrates two end connectors 14 and 18 releasably held by the holder 100. Holder 100 can comprise first portion 110 for releasably holding an electrical end connector 14, and a second portion 120 for releasably holding and end connector 18. The first and second portions 110 and 120 can provide recesses which are sized and shaped to accommodate releasably holding the end connectors. For instance, if the end connectors have a generally cylindrically shaped body (such as in FIG. 3), the first and second portions 110 and 120 can each defined a generally cylindrically shaped recess for accommodating the end connector bodies.

In FIGS. 2 and 3, holder 100 comprises first portion 110 and second portion 120 spaced apart by a body portion 150. The body portion 150 can include a top surface 152, a bottom surface 154, and spaced apart sides 156 and 158. The first and second portions 110 and 120 engage the end connectors 14 and 18 and can provide a desired, predetermined, generally parallel spacing of the longitudinal axis of each of the end connectors 14 and 18, one from the other. The holder 100 provides center to center spacing of the end connectors 14 and 18 and helps to prevent tangling and twisting of the wire ends attached to the end connectors.

In FIGS. 2 and 3, the first portion 110 comprises a plurality of tab extensions 112, 114, and 116 extending from the side 156 of body portion 150. Similarly, the second portion 120 can comprise a plurality of tab extensions 122, 124, 126 extending from the side portion 158 of the body portion 150. The tab extensions can be formed from a suitable resilient material and can be suitably dimensioned to provide a compressive force for engaging and retaining end connectors 14 and 18 when connectors 14 and 18 are disposed in the holder 100 in a desired center to center spacing. The tab extensions can be sized and shaped to releasably engage a generally cylindrical insulator body of banana plug connectors.

In one embodiment, the holder 100, including body 150 and tab extensions 112, 114, 116, 122, 124, and 126 can be formed, such as by molding or casting, as a unitary piece. By “unitary” it is meant that the holder 100 is formed to be a complete device, with no assembly required, and with no removable parts. The body 150 and tab extensions are preferably formed of a non-conductive material. For instance, the holder 100 can be formed as a unitary piece made of a suitable synthetic material (e.g. plastics) or natural material (e.g. rubber). Suitable materials include thermoplastics and thermosetting polymers, including for instance polyamides. One suitable material comprises a polymer comprising a chain like structure, such as for instance Nylon 6/6. In one embodiment, holder 100 can be an injection molded unitary structure formed of Nylon 6/6. “Engineering Materials and Their Application”, Finn and Trojan, 1975, Chapters 9 and 10, is incorporated herein by reference for disclosure related to properties and applications of materials, including Nylon 6/6. Alternatively, the body 150 can be formed from a different material than the material from which the tab extensions are formed.

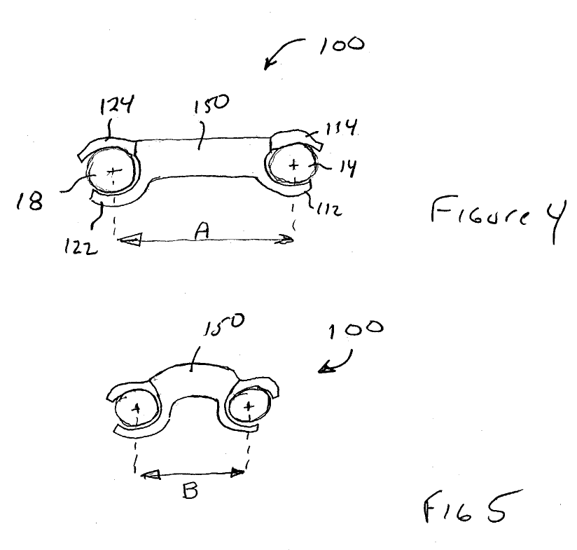

The holder can have a total length (measured parallel to the axis of the electrical end connector) of about 0.25 inches to about 2 inches, a width of about 0.5 inches to about 2 inches, a height (measured perpendicular to center to center spacing A in FIG. 4) of no more than about 0.45 inch, and can provide a center to center spacing of about 0.5 inches to about 1.5 inches. In the embodiment shown, the holder can have a weight of no more than about 20 grams, and more particularly, no more than about 10 grams. The tab extensions can have a thickness of about 0.05 inch, and the body 150 can have a thickness (measured parallel to the height dimension) of about 0.2 inch. Such a holder 100 can be disposable, such as for instance after one use or a relatively small number of uses.

The center to center spacing provided by holder 100 can be a predetermined, fixed spacing for a particular socket spacing associated with a particular generator. If desired, a kit of holders 100 can be provided with various center to center spacings to accommodate different generator/power source that may be encountered in practice.

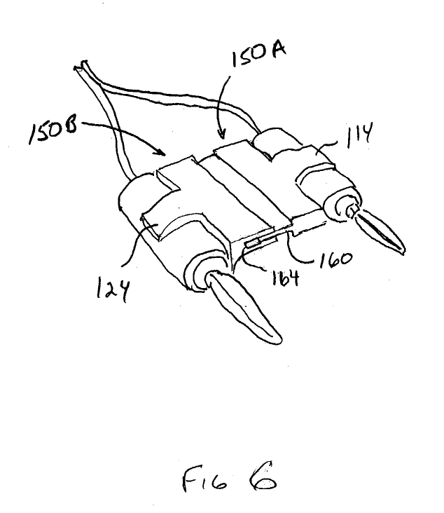

In one embodiment, the holder 100 can be adapted to provide variable center to center spacing. For instance, in FIGS. 4 and 5, a holder 100 is illustrated which can be deformed or otherwise adapted to provide different center to center spacings (labeled A and B in FIGS. 4 and 5). In one embodiment, at least the body portion of holder 100 can be formed of a material that is deformable to provide different center to center spacings. For instance, the body portion could be formed from a material that is resiliently deformable (or alternatively, permanently deformable such as by plastic deformation) to allow the tab extensions engaging an end connector on side of the holder 100 to be displaced relative to the tab extensions engaging an end connector on the side of the holder 100.

FIG. 6 illustrates an alternative embodiment of the holder 100 for providing variable center to center spacing of electrical end connectors. In FIG. 6, holder 100 has a body comprising a first body portion 150A which slidably engages a second body portion 150B. First body portion 150A includes a tongue 160 which engages a groove 164 in second body portion 150B to provide for variation in the center to center spacing of electrical end connectors engaged by tab extensions associated with each of the first and second body portions 150A and 150B.

An alternative embodiment can comprise a holder 100 having a selectively weakened portion (such as in the body 150) to allow the holder 100 to be broken apart along the selectively weakened portion positioned between the first and second portions 110/120 holding the end connectors. A selectively weakened portion could be provided by a ‘thinned’ portion of material, by a ‘score line’, or by any other suitable dimensional or material feature which would permit the holder to be broken intermediate the portions 110/120, in the event it is desirable separate the end connectors while the connectors are still engaged by the first and second portions 110 and 120.

While the present invention has been illustrated by description of several embodiments and while the illustrative embodiments have been described in considerable detail, it is not the intention of the applicant to restrict or in any way limit the scope of the appended claims to such detail. Further, various elements of the present invention can be equivalently described in terms of a means for accomplishing the elements' associated functions.

What is claimed is:

1. An electrical connector holder comprising:
a body portion, the body portion comprising a top surface, a bottom surface, and two spaced apart sides;
a first portion disposed on one side of the body portion for releasably holding an electrical end connector;
a second portion disposed on an opposite side of the body portion for releasably holding an electrical end connector.

2. An electrical connector holder comprising
a non-conductive body portion;
a first plurality of tab extensions extending from the body portion for releasably holding a first electrical end connector; and
a second plurality of tab extensions extending from the body portion for releasably holding a second electrical end connector.

3. The holder of claim 2 wherein the body portion and the tab portions comprise a unitary structure.

4. The holder of claim 2 wherein the holder is formed of a non-metallic material.

5. The holder of claim 2 wherein the holder is injection molded.

6. The holder of claim 2 comprising at least four tab extensions.

7. The holder of claim 2 comprising at least six tab extensions.

8. The holder of claim 2 wherein the holder weighs no more than about 20 grams.

9. The holder of claim 2 wherein the holder has a height of no more than about 0.5 inch.

10. The holder of Claim comprising a unitary structure formed of material selected from the group consisting of polymers and natural rubbers.
